(19) United States
(12) Patent Application Publication
(10) Pub. No.: US 2023/0258292 A1
(43) Pub. Date: Aug. 17, 2023

(54) SEALING DEVICE FOR PLUGGING A LEAK IN THE WALL OF A PIPE OR OF A TANK COMPRISING A PART FOR DRILLING AND A PART FOR TAPPING AND SEALING METHOD

(71) Applicant: 3X ENGINEERING, MONACO (MC)

(72) Inventors: Stanislas BOULET D'AURIA, VILLEFRANCHE SUR MER (FR); Hacen SLIMANI, NICE (FR)

(21) Appl. No.: 18/014,192

(22) PCT Filed: Jul. 2, 2021
(86) PCT No.: PCT/EP2021/068339

§ 371 Date: Jan. 3, 2023

(30) Foreign Application Priority Data
Jul. 3, 2020 (FR) 2007060

(51) Int. Cl. F16L 55/16

(52) U.S. Cl. CPC F16L 55/1612

(57) ABSTRACT

The invention relates to a sealing device with a longitudinal axis for plugging a leak in the wall of a pipe or tank, further comprising a drive means at one end, a plug and a tap. According to the main features, at its other end the device comprises a drilling head suitable for drilling a cylindrical hole in the thickness of the wall at the location of the leak, the plug comprises a thread and a thread runout chamfer on which the thread ends, the end of the thread extending to a clearance groove and a smooth upper chamfer suitable for deforming the thread at the end of internal thread, the hole being intended to be sealed by the plug.

The invention also relates to a method for sealing a leak in the wall of a pipe or tank.

### TECHNICAL FIELD

The present invention relates to devices for repairing pipelines, pipes, and ducts intended to transport fluids or gas under pressure and relates in particular to a sealing device for plugging a leak in the wall of a pipe or tank, comprising a drilling part and a tapping part, and sealing method.

### BACKGROUND ART

Pipelines or pipes transporting gas or liquid under pressure over long distances are subject to damage such as internal and external corrosion, impact or sabotage. It often happens that the pipe is damaged to the point of causing a leak of its contents due to the formation of a crack or hole. Repair solutions have been developed to stop these local leaks, for example, by welding a steel plate at the location of the hole. However, this solution has the disadvantages of using heavy equipment and taking a long time to implement. On the other hand, its material and labor cost is high, and sometimes its implementation is impossible in certain closed places. Another solution is to apply a steel plate wrapped with composite over the hole. The implementation of this solution is delicate, and its reliability is uncertain because it depends on the ambient temperature and the materials, which makes it very difficult to achieve on a submerged pipe.

The solution consisting in sealing by applying a mastic can be used on pipes under low pressure and is temporary.

Finally, one solution is to install a threaded plug. However, this requires having a perfectly circular hole and tapping aligned with the axis of the hole. Tapping, usually carried out after the drilling step, needs to be perfectly aligned and centered on the drilling axis. In addition, the plug must then be gently introduced so as to avoid cross-threading resulting in a leak path along the threads. Such damage represents an additional difficulty in the case of a pressurized and submerged pipe.

A prior art pipe plug described in document EP0951626 comprises a self-tapping part which allows, during the installation of the plug in the conical hole in which it is inserted, to create a thread on the inner wall of the hole. At its end, the plug comprises sealing rings whose diameter is smaller than the decreasing initial diameter of the conical hole in which the plug is inserted. The sealing rings come into contact with the inner wall of the hole as the plug head approaches its position against the pipe. Such a plug requires a conical hole to be drilled in advance to the dimensions of the plug.

The document JPH09210285A describes a device for sealing a leakage hole comprising a self-tapping screw adapted to be screwed into the leakage hole when tapped with a hammer and provided with a cylindrical seal. This solution has the disadvantage of requiring extensive resources in the case of a pressurized and submerged pipe.

### SUMMARY OF THE INVENTION

This is why the object of the invention is to overcome the aforementioned drawbacks by providing a sealing device comprising a plug, a tap and a drill.

Another object of the invention is to provide a method of sealing a leak in the wall of a pipe or tank performed in a single step.

The object of the invention is, therefore, a sealing device with a longitudinal axis (Z, Z′) for plugging a leak in the wall of a pipe or tank further comprising a drive means at one end, a plug and a tap, the device comprising at its other end a drilling head adapted to drill a cylindrical hole in the thickness of the wall of the pipe at the location of the leak, the tap creating threads on the inside of the smooth walls of the cylindrical hole. According to the main characteristics, the plug comprises a thread and a thread runout chamfer on which the thread ends, the end of the thread extending over a clearance groove and a smooth upper chamfer suitable for deforming the thread at the internal thread end, said hole being intended to be sealed by the plug.

Advantageously, the device according to the invention is installed in the wall of a pipe at the location of the opening causing a leak, in a single operation which includes drilling [a hole] in the thickness of the wall of the pipe, tapping and installing a threaded plug in the drill hole. On the other hand, the device comprises means for disassembling the drilling and tapping tool part from the plug and drive means part. This part becomes useless as soon as the plug part is installed and can even contribute to obstructing the passage of instruments inside the pipe. In order to check the proper functioning and condition of certain pipes, such as oil or gas pipes, the interior of the pipe is inspected by means of a tool called an instrumented scraper which moves inside the pipe. The possibility of disassembling the drilling and tapping tool part from the plug and drive means part is, therefore, particularly advantageous for this type of pipe.

According to a second object, the invention relates to a process for sealing a leak in the wall of a pipe or tank in a single step, comprising the following five sub-steps:
centering the sealing device on the location of the leak,
rotating the sealing device around its longitudinal axis (Z-Z′) using a rotation drive tool,
drilling the wall of the pipe using a drilling head located at the end of the sealing device and making a cylindrical hole,
tapping the smooth inner wall of the cylindrical hole using the tap of the sealing device,
screwing the plug located at the other end of the sealing device into the tapped hole until the upper chamfer of the sealing device fully penetrates the cylindrical hole so as to exert strong pressure on the internal thread and work-harden the end of the thread forming the internal thread.

### BRIEF DESCRIPTION OF THE DRAWINGS

The purposes, objects and characteristics of the invention will become more apparent from the following description when taken in conjunction with the accompanying drawings in which:

FIG. 1 shows a schematic view of a first embodiment of the device according to the invention,

FIG. 2 shows a schematic view of a second embodiment of the device according to the invention,

FIG. 3 shows a variant of the first embodiment of the device according to the invention,

FIG. 4 shows a variant of the second embodiment of the device according to the invention,

FIG. 5 shows the first embodiment of the device according to the invention with a first means for disassembling the plug part,

FIG. 6 shows the first embodiment of the device according to the invention with a second means for disassembling the plug part,

FIG. 7 shows the first embodiment of the device according to the invention with a third means for disassembling the plug part,

FIG. 8a shows the first sub-step of the sealing method according to the invention,

FIG. 8b shows the second and third sub-steps of the sealing method according to the invention,

FIG. 8c shows the fourth sub-step of the sealing method according to the invention,

FIG. 8d shows the fifth sub-step of the sealing method according to the invention,

FIG. 9 shows an alternative embodiment of the sealing method according to the invention,

FIG. 10 shows another alternative embodiment of the sealing method according to the invention.

### DETAILED DESCRIPTION OF THE INVENTION

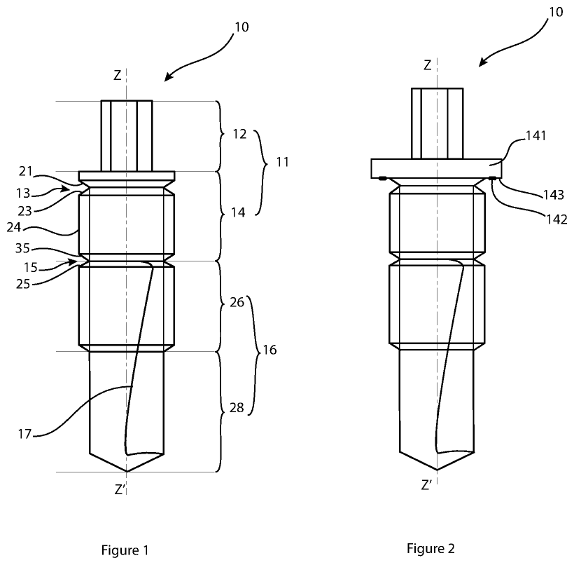

With reference to the figures and in particular to FIG. 1, the sealing device 10 according to the invention is in the form of a rod with a longitudinal axis (Z-Z′) which comprises, at one of its ends, a self-drilling and self-tapping first part 16 and, at the other end, a second part 11 comprising a plug 14 to seal a cylindrical hole in the wall in which the device will be installed, and a drive means 12.

The self-drilling and self-tapping part 16 comprises a tap 26, or self-tapping thread, and a drilling head 28 in the form of a drill. The drilling head 28 comprises at least one flute 17 adapted to evacuate the chips during drilling. The flute 17 extends over the part of the tap 26. The drilling head has a sufficient diameter so that the cylindrical hole created replaces and eliminates the opening causing the leak. This diameter is generally between 7 mm and 15 mm. The length of the drilling head is greater than the thickness of the wall to be drilled in order to evacuate as many chips as possible.

The tap 26 has a root diameter equal to the diameter of the drill head 28. The height of the thread of the tap 26 is between 10 mm and 20 mm and is preferably equal to 15 mm. The thread pitch of the tap 26 is generally between 1 mm and 2 mm and preferably equal to 1.25 mm to induce little torque force during the tapping step. On the side opposite the drilling head 28, and according to one embodiment, the tap 26 ends in a thread runout chamfer 25 sloping at an angle of about 30 degrees with a plane perpendicular to the longitudinal axis (Z-Z′). The chamfer 25 creates an annular constriction 15 with a diameter at most equal to the diameter of the drilling head, therefore also at most equal to the root diameter of the tap 26.

The annular constriction 15 extends over the plug 14, which comprises a thread 24 whose nominal diameter is equal to the nominal diameter of the tap 26, whose thread height is equal to the height of the thread of the tap and whose thread pitch is equal to the thread pitch of the tap 26. The thread 14 begins with a chamfer 35 at the start of the thread sloping at an angle of about 30 degrees with a plane perpendicular to the longitudinal axis (Z-Z′). The two chamfers 25 and 35 form an angle of about 60 degrees between them, the annular constriction 15 being located at the junction of the two chamfers, therefore between the first and the second part.

Even when the thread 24 of the plug 14 and the tap 26 are separated by the annular constriction 15, the helical shape of their respective thread is continuous with one another. More precisely, the thread 24 is an extension of the tap 26 so that the set of the two forms a single helicoid interrupted by the annular constriction 15. The end of the thread which constitutes the thread 24 of the plug 14 extends over a clearance groove 13 which comprises a thread runout chamfer 23 on which, as its name suggests, the thread 24 ends, and an upper chamfer 21. The thread runout chamfer 23 makes an angle between 30 and 50 degrees with a plane perpendicular to the longitudinal axis (Z-Z′). The upper chamfer 21 also makes an angle between 30 and 50 degrees with a plane perpendicular to the longitudinal axis (Z-Z′). The thread runout chamfer 23 makes an angle between 60 and 100 degrees with the upper chamfer 21. The two chamfers 23 and 21 delimit the clearance groove 13 in which a sealing paste, a ring, a gasket or any other sealing means can be housed. On the other hand, the upper chamfer 21 is smooth so as to be able to crush and work-harden the thread at the internal thread end produced by the tap 26 so as to deform it. Thus, the crushed material of the thread at the internal thread end tends to move into the root of the thread and achieves a tight junction when the plug 14 is installed in the cylindrical hole created by the tap 26. The crushing and material displacement effect is also achieved in the direction of the walls of the cylindrical hole due to the angle of the chamfer. Consequently, the device comprises a chamfer deforming the thread at the internal thread end produced by the tap 26 when the device is installed. The drive means 12 serves to cooperate with a tool to rotate the device according to the invention around its longitudinal axis (Z-Z′). The drive means 12 may be a hexagonal cross-sectional shank or a hexagonal-shaped recess of the hexagon socket type. Any other type of drive means can be used without departing from the scope of the invention.

According to a second embodiment illustrated in FIG. 2, the plug 14 comprises a plug head 141 located between the upper chamfer 21 and the drive means 12. The plug head 141 has a diameter greater than the nominal diameter of the thread 24 and comprises a peripheral shoulder 143 on which an annular seal 142 is mounted. The peripheral shoulder 143 is intended to abut against the wall of the pipe or tank when the device according to the invention is installed; thus, the annular seal 142 serves as an additional sealing means, in addition to the thread of the plug. It should be noted that when the diameter of the pipe is about 100 times greater than the diameter of the thread 24 of the plug 14, the entire annular seal is in contact with the wall when the sealing device is fitted tightly in its housing.

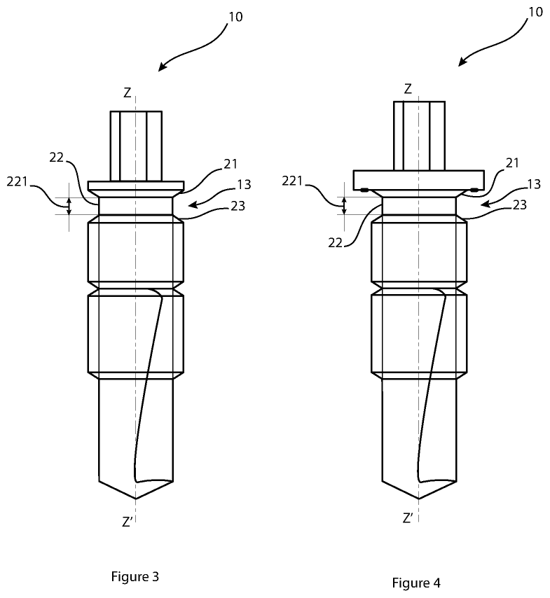

A variant of the first and second embodiments of the device according to the invention is illustrated in FIGS. 3 and 4. According to this variant, the clearance groove 13 comprises a cylindrical part 22, whose length is represented by the double arrow 221 in the figures. The diameter of the cylindrical part 22 is equal to the root diameter of the thread 24 of the plug 14. The configuration in which the length of the cylinder is zero corresponds to the embodiments described above with reference to FIGS. 1 and 2. According to the alternative embodiment, the length 221 of the cylindrical part 22 is preferably between 1 and 5 mm.

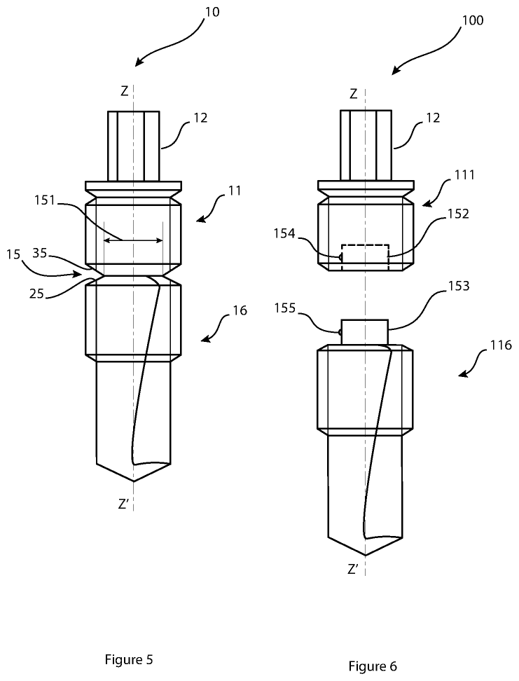

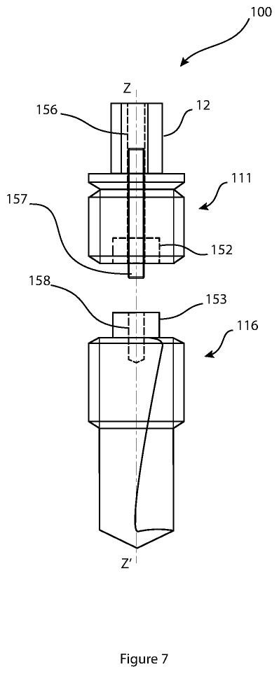

FIGS. 5, 6 and 7 illustrate a device provided with means for disassembling the two parts of the device once it has been installed, either starting from a sealing device made of a single piece like the one illustrated in FIG. 5 or starting from a sealing device made from the reversible assembly of the two parts originally separated from each other as on the sealing devices 100 illustrated in FIGS. 6 and 7. FIG. 5 describes a means for disassembling the first part from the second part of a sealing device 10 implemented when the second part is installed in the pipe wall. The annular constriction 15 being located at the junction of the two parts and at the junction of the two chamfers 25 and 35, the plane of separation of the two parts is located at the bottom of this groove in a plane perpendicular to the longitudinal axis (Z-Z′) of the sealing device.

According to FIG. 5, the annular constriction 15 has a minimum diameter less than the diameter of the drilling head and preferably this diameter is between 75% and 85% of the diameter of the drilling head. According to these dimensions, the annular constriction 15 of the sealing device is an incipient break. The annular constriction 15 of minimum diameter illustrated by the double arrow 151 corresponding to this value is therefore a means for disassembling the two parts located on either side of the annular constriction 15 which, being severed, allows the first part, or self-drilling and self-tapping part 16, to separate from the second part made up of the plug 14 and the drive means 12.

FIGS. 6 and 7 illustrate a sealing device 100 according to the invention made up of two parts 116 and 111, equivalent to parts 16 and 11 of the sealing device 10 described above, but in which the parts are originally separate from one another and can be assembled and disassembled. The sealing device 100 therefore comprises means for assembling and disassembling the two parts. The first part 116 comprising the self-drilling and self-tapping part 16 and the second part 111 comprising the plug 14 and the drive means 12. The first part is assembled with the second part by means of an assembly of parts embedded in each other to form the sealing device 100 in the form of a one-piece rod prior to installation in the pipe wall.

According to FIG. 6, the first part 116 comprises a part 153 with a square cross-section located on the junction plane of the two parts. Part 153 has a ball 155 on one of its faces. The second part 111 comprises a recess 152 which extends through the thickness of the plug from the junction plane of the two parts, the recess 152 having a square cross-section and a shape corresponding to the shape of the part 153. Part 153 and recess 152 have the longitudinal axis (Z-Z′) as their axis of symmetry and are oriented relative to each other so that when part 153 is inserted into recess 152, the two parts 116 and 111 are aligned so as to form one of the devices according to the invention as described above and represented in FIGS. 1 to 5. When the plug 14 is rotated by the drive means 12, it rotates the self-drilling and self-tapping part 116 thanks to the embedding of the part 153 in the recess 152. During the installation of the sealing device, the two parts are held against each other by the pressure exerted by the tool on the pipe.

The recess 152 also comprises on one of its faces a spherical hollow 154 corresponding to the diameter of the ball 155 and intended to partially house the ball in order to block the square part 153 in the recess 152 in a reversible manner. The ball 155 and the spherical hollow 154 form part of the means for assembling and disassembling the two parts of the sealing device. The device according to the invention can thus be manipulated without the two parts disassembling unintentionally. The first part 116 is disassembled from the second part 111 by a pulling force in the direction (Z-Z′) or by a pushing force in a direction perpendicular to the axis (Z-Z′) sufficient to allow the ball 155 to come out of its housing 154. This pushing force can be obtained by the passage of the instrumented scraper which, upon reaching the sealing device, exerts sufficient pressure on it to disassemble the drilling and tapping tool part 116.

FIG. 7 illustrates the device according to the invention in which the self-drilling and self-tapping part 116 is assembled to the second part 111 made up of the plug 14 and the drive means 12 thanks to an assembly of parts embedded in each other. As for the second means illustrated in FIG. 6, the first part 116 comprises a part 153 with a square cross-section and the second part 111 comprises in the thickness of the plug a recess 152 with a square cross-section whose shape corresponds to the shape of the part 153. Part 153 and recess 152 have the longitudinal axis (Z-Z′) as their axis of symmetry so that, when part 153 is inserted into recess 152, the two parts 116 and 111 are aligned so as to form one of the devices according to the invention as illustrated in FIGS. 1 to 5.

On the other hand, the sealing device 100 comprises an internal thread 158 located in the first part 116 and a through internal thread 156 located in the second part 111. The two internal threads, being aligned and centered on the longitudinal axis (Z-Z′), have a diameter and threads of identical characteristics. The device also comprises a threaded rod 157 adapted to the internal threads 156 and 158 and screwed inside. The threaded rod passes through the drive means 12 and the plug 14 to the self-drilling and self-tapping part 16 which it holds tight against the plug 14.

The first part 116 is disassembled from the second part 111 by unscrewing the threaded rod 157 accessible in the middle of the drive means 12. By unscrewing the threaded rod 157, it gradually comes out of the internal thread 158. The second part 116 then falls by gravity or else, as for the embodiment described according to FIG. 6, the first part 116 is disassembled from the second part 111 by a thrust force in a direction perpendicular to the axis (Z-Z′), force which can be obtained by the passage of the instrumented scraper.

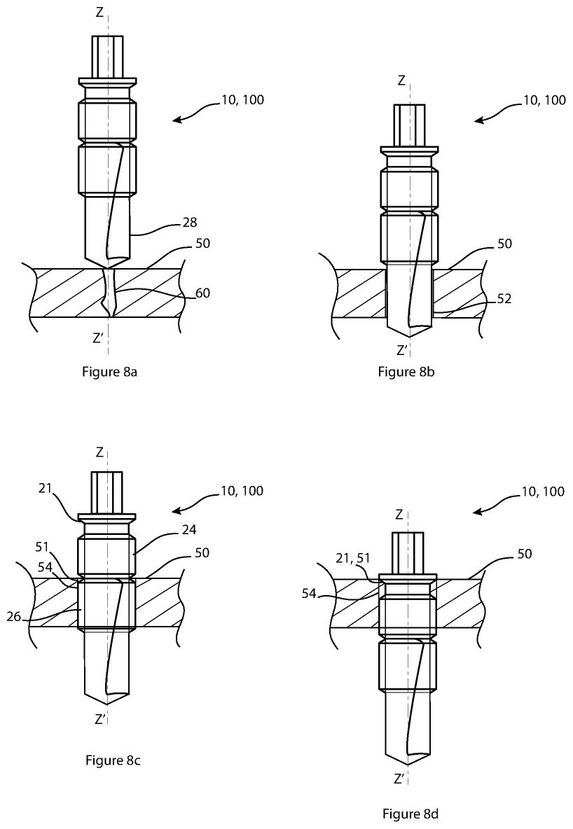

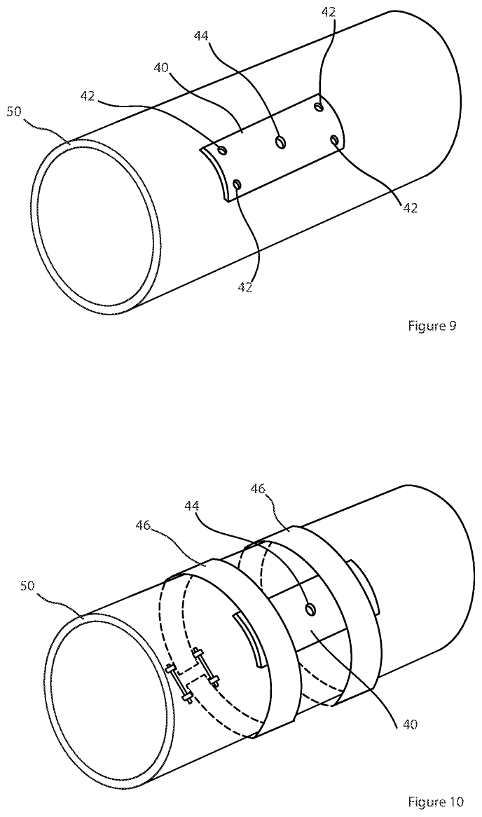

The present invention also relates to a method for sealing a leak in a pipe or a tank in a single operation or step, the various sub-steps of which are illustrated in FIGS. 8a, 8b, 8c and 8d. This method consists in centering the sealing device 10 or 100 according to the invention at the location of a leak 60 on the wall 50 of a pipe or tank, in drilling the wall 50 right through on the part causing the leak by means of a drive tool which rotates the sealing device. The operator will have taken care to choose the tool accessory suitable for the drive tool and the drive means 12. The wall 50 is drilled using the drilling head 28 and a cylindrical hole 52 is obtained in place of the leak 60. While the rotation drive tool of the device according to the invention is held in place, the tap 26 creates an internal thread 54 within the smooth walls of the cylindrical hole 52. The sealing device 10 or 100 is rotated by the tool until the plug 14 is sealingly installed in the hole 52. To this end, the thread 24 of the plug 14 engages the internal thread 54 until the upper chamfer 21 comes into contact with thread 51 at the end of internal thread 54. The upper chamfer 21 is the last part of the plug 14 which engages the cylindrical hole 52.

The upper chamfer 21 being smooth, it crushes and works hardens the thread 51 at internal thread end so as to deform it. The crushed material of the thread tends to move into the root of the thread and achieves a tight junction when the plug 14 is installed in the hole 52. The crushing and material displacement effect is also achieved in the direction of the walls of the cylindrical hole thanks to the angle of the chamfer comprised between 30 and 50 degrees with respect to a plane perpendicular to the longitudinal axis (Z-Z′).

The method for sealing a leak 60 on a wall 50 of a pipe or tank produced in a single step comprises the following sub-steps:
centering the sealing device 10 or 100 on the location of the leak 60,
rotating the sealing device 10 or 100 around its longitudinal axis (Z-Z′) using a rotation drive tool,
drilling the wall 50 of the pipe using the drilling head 28 located at the end of the sealing device 10 or 100 and making a cylindrical hole 52,
tapping to form an internal thread 54 on the smooth inner wall of the cylindrical hole 52 using the tap 26 of the sealing device 10 or 100,
screwing the plug 14 located at the other end of the sealing device 10 or 100 into the tapped hole until the upper chamfer 21 of the sealing device 10 or 100 fully penetrates the cylindrical hole so as to exert strong pressure on the thread and work harden the thread end 51 of the internal thread 54.

Prior to these sub-steps, the release groove 13 can be filled with a sealing paste or else with a gasket or a sealing ring or with any other means. Once the sealing device 10 or 100 is installed, the sealing paste or any other means is trapped between the internal thread 54 and the release groove 13 of the sealing device 10 or 100.

Once the sealing device 10 or 100 is installed, the threads of the thread 24 of the plug 14 and those of the internal thread 54 are in close contact against each other and also provide a seal. However, the last sub-step is important to guarantee a perfect seal. When the end thread 51 of the internal thread 54 is crushed, it undergoes a plastic deformation which is the result of work hardening under the pressure exerted by the metal of the upper chamfer 21. The deformed metal which has become harder and inelastic makes it possible to make the plug 14 perfectly sealed. After this step, the upper chamfer 21 has fully penetrated the cylindrical hole 52.

The tap must have finished tapping the hole before the threads of the plug begins to engage the internal thread 54 of the hole 52 to avoid shifting of the threads which could interfere with the installation of the plug. Actually, when the tap has finished tapping, all the chips and wall residues removed and accumulated have been evacuated, which is essential to prevent the thread 24 of the plug from engaging in the internal thread 54 with shifting. Therefore the length of the tap 26 must be at least equal to the thickness of the wall 50. The length of the plug is also at least equal to the thickness of the wall. Preferably the plug and the tap have the same length. The length of the plug 14 is understood as being the length of the thread 24 to which is added the length of the cylindrical part 22 of the clearance groove 13, with the height of the chamfers 21 and 23 being included. The dimensions of the sealing device 10 or 100 are adapted for each wall thickness 50.

According to a second sealing method, the sealing device 10 according to the invention is associated and centered on a plate 40 which matches the curvature of the wall 50 of the pipe or tank as can be seen illustrated in FIGS. 9 and 10. The metal plate 40 is positioned on the wall 50 so that the opening 60 causing the leak appears in an orifice 44 provided in the plate 40. The screws 42 attaching the plate can be through-the-wall if the screwing area is sound and can be non-through-the-wall if the screwing area is damaged. In the case of through screws, a means for sealing the screws will be provided. The plate 40 can also be attached to the wall using at least one strap 46 or by bonding.

The plate 40 makes it possible to reinforce the wall 50 when the latter is altered around the opening 60 causing the leak. The diameter of the orifice 44, preferably provided in the center of the plate 40, is greater than the largest diameter of the sealing device so as to form a passage for the sealing device large enough so that the operator is not hampered by the plate during the installation of the sealing device in the orifice 44. The materials that make up the sealing device and the plate 40 can be steel, metal or plastic composite.

1. A sealing device with a longitudinal axis for plugging a leak in the wall of a pipe or tank further comprising a drive means at one end, a plug and a tap, the device comprising at its other end a drilling head adapted to drill a cylindrical hole in the thickness of the wall at the location of the leak , said tap creating an internal thread within the smooth walls of the cylindrical hole.
wherein the plug comprises a thread and a thread runout chamfer on which the thread ends, the end of the thread extending over a clearance groove and a smooth upper chamfer suitable for deforming the thread at the end of internal thread, said hole being intended to be sealed by the plug.

2. The sealing device according to claim 1 comprising two parts, the first part consisting of the self-drilling and self-tapping part comprising the drilling head and the tap, said first part ending in a thread runout chamfer forming a slope of about 30 degrees with a plane perpendicular to the longitudinal axis and the second part consisting of the plug and the drive means, said plug comprising a thread start chamfer forming a slope of about 30 degrees with a plane perpendicular to the longitudinal axis, said two chamfers and forming an angle of about 60 degrees with each other, an annular constriction being located at the junction of the two parts with a diameter at most equal to the diameter of the drilling head.

3. The sealing device according to claim 2, comprising means for disassembling the first part from the second part.

4. The sealing device according to claim 2, wherein the means for disassembling comprise an annular constriction with a diameter between 75% and 85% of the diameter of the drilling head, the annular constriction then constituting an incipient break.

5. The sealing device according to claim 2, the first part and the second part of which are originally separate from each other, wherein the means for disassembling the first and the second parts are also means for assembling them, said means further comprising a part of square cross-section located on the first part on the joining surface of the two parts and a recess which extends into the thickness of the plug from the junction plane of the two parts, said recess having a square cross-section and a shape corresponding to the shape of the part, the part and the recess have the longitudinal axis as axis of symmetry.

6. The sealing device according to claim 4, wherein said means also comprise a ball located on one of the faces of the part and a spherical hollow located on one of the faces of the recess and intended to partially accommodate said ball in order to block the square part in the recess in a reversible manner.

7. The sealing device according to claim 4, wherein said means also comprises an internal thread located in the first part and a through internal thread located in the second part, the two threads, being aligned and centered on the longitudinal axis, have a diameter and threads of characteristics identical, said device also comprising a threaded rod adapted for the internal threads and screwed inside, said threaded rod passes through the drive means and the plug up to the self-drilling and self-tapping part which it holds tight against the plug.

8. The sealing device according to claim 1, wherein the length of the tap is at least equal to the thickness of the wall.

9. The sealing device according to claim 1, wherein the tap has a root diameter which is equal to the diameter of the drilling head, the height of the thread of the tap is between 10 mm and 20 mm and is preferably equal to 15 mm, the thread pitch of the tap is between 1 mm and 2 mm and preferably equal to 1.25 mm.

10. The sealing device according of claim 2, wherein the thread of the plug has a nominal diameter equal to the nominal diameter of the tap, and a thread pitch equal to the pitch of the self-tapping thread, the thread being an extension of the tap so that the set of the two forms a single helicoid interrupted by the annular constriction.

11. The sealing device according of claim 1, wherein the thread runout chamfer forms an angle between 30 and 50 degrees with a plane perpendicular to the longitudinal axis of the sealing device.

12. The sealing device according of claim 1, wherein the clearance groove comprises a cylindrical part with a length, the diameter of the cylindrical part being equal to the root diameter of the thread of the plug, the length of the cylindrical part is between 1 and 5 mm.

13. The sealing device according to claim 12, wherein the length of the plug including the length of the thread, the length of the clearance groove and the height of the chamfers and is at least equal to the thickness of the wall.

14. The sealing device according claim 1, wherein the plug comprises a plug head having a diameter greater than the nominal diameter of the thread and a peripheral shoulder on which an annular seal is mounted, the peripheral shoulder being intended to abut against the wall of the pipe when the sealing device is installed.

15. A method for sealing a leak on the wall of a pipe, comprising the following sub-steps:
centering the sealing device according to claim 1 on a location of the leak,
rotating the sealing device around its longitudinal axis using a rotation drive tool,
drilling the wall of the pipe using a drilling head located at the end of the sealing device and making a cylindrical hole,
tapping to form an internal thread on the smooth inner wall of said cylindrical hole using the tap of the sealing device,
screwing the plug located at the other end of the sealing device into the tapped hole until the upper chamfer of the sealing device fully penetrates the cylindrical hole so as to exert strong pressure on the internal thread and work-harden the end of the thread forming the internal thread.

16. The method for sealing a leak according to claim 15, wherein before carrying out the sub-steps, a plate is attached to the wall at the location of the leak, the shape of said plate being adapted to the curvature of said wall, said plate comprising an orifice provided for the passage of the sealing device.

17. The method for sealing a leak according to claim 16, wherein the plate is attached to the wall by means of screws.

18. The method for sealing a leak according to claim 16, wherein the plate is attached to the wall by means of at least one strap.

19. The method for sealing a leak according to claim 16, wherein the plate is attached to the wall by bonding.
